(19) United States
(12) Patent Application Publication
(10) Pub. No.: US 2018/0018657 A1
(43) Pub. Date: Jan. 18, 2018

(54) MOBILE TERMINALS PROVIDING SECURE USER INTERFACES

(71) Applicant: CA, Inc., New York, NY (US)

(72) Inventors: Yashwant Ramkishan Sawant, Parbhani (IN); Mohammed Mujeeb Kaladgi, Bangalore (IN); Sandeep Banisetti, Srikakulam (IN); Ruqiya Nikhat Kaladgi, Bangalore (IN)

(73) Assignee: CA, Inc., New York, NY (US)

(21) Appl. No.: 15/212,564

(22) Filed: Jul. 18, 2016

(51) Int. Cl. G06Q 20/36; G06Q 20/40; G06Q 20/32

(52) U.S. Cl. CPC G06Q 20/36; G06Q 20/322; G06Q 20/40

(57) ABSTRACT

A mobile terminal performs operations that include receiving an authentic account identifier through a user interface from a user. Responsive to a request to enroll an account in a mobile wallet application executed by the processor of the mobile terminal, an enrollment request message is communicated via a network interface of the mobile terminal and a data network toward a wallet server. The enrollment request message includes an authentic account identifier received from a user. An enrollment response message containing a plurality of decoy account identifiers is receiving through the network interface from the wallet server. The plurality of decoy account identifiers are saved in a memory of the mobile terminal logically associated by a data structure with the authentic account identifier. Corresponding operations by a wallet server are disclosed.

### BACKGROUND

The present disclosure relates to computer information security and, more particularly, to user interfaces that provide secure access to applications executed by electronic mobile terminals.

Passwords or personal identification numbers (PINs) remain the dominant approach for user authentication by computer systems because of their simplicity, legacy deployment and ease of revocation. Unfortunately, common approaches to entering passwords or PINs by way of keyboard, mouse, touch screen or any traditional input device, are vulnerable to attacks such as shoulder surfing and password or PIN snooping.

Shoulder-surfing is an attack on password or PIN authentication that has traditionally been hard to defeat. It can be done remotely using binoculars and cameras, using keyboard acoustics, or embedded keystroke tracking software. Access to the user's password or PIN simply by observing the user entries undermines the effort of encrypting information and protocols for authenticating the user securely. To some extent, the human actions when inputting the password or PIN are the weakest link in the chain.

Biometric authentication approaches, which identify individuals based on physiological characteristics, have the advantage that they are harder to replicate and therefore are not susceptible to the risks of shoulder surfing. However, biometric techniques suffer from the drawback that they can be error prone by granting access to false-positive biometric matches and the physiological characteristics forming a biometric are nonsecret and non-revocable. While it is easy for a user to change a password, it is perhaps not possible for the user to change a fingerprint.

### SUMMARY

Some embodiments of the present disclosure are directed to a method of performing operations on a processor of a mobile terminal. The method includes responding to a request to enroll an account in a mobile wallet application executed by the processor of the mobile terminal, by communicating an enrollment request message via a network interface of the mobile terminal and a data network toward a wallet server. The enrollment request message includes an authentic account identifier received from a user. An enrollment response message containing a plurality of decoy account identifiers is receiving through the network interface from the wallet server. The plurality of decoy account identifiers are saved in a memory of the mobile terminal logically associated by a data structure with the authentic account identifier.

In some further embodiments, responsive to a user initiating a transaction through the mobile wallet application, the operations display on a display device of the mobile terminal the plurality of decoy account identifiers and the authentic account identifier. Responsive to receiving a user selected account identifier that is displayed among the plurality of decoy account identifiers and the authentic account identifier, the operations communicate through the network interface toward the wallet server a transaction request message containing the user selected account identifier. A transaction response message is received through the network interface from the wallet server. The transaction response message contains an authorization indication. The operations selectively allow completion of the transaction through the mobile wallet application based on the authorization indication.

Some other embodiments of the present disclosure are directed to a method of performing operations on a processor of a wallet server. The method includes receiving, via a network interface of the wallet server from a mobile wallet application executed by the mobile terminal, an enrollment request message an authentic account identifier to be enrolled for a user. A plurality of decoy account identifiers are selected, and are saved in a memory of the wallet server logically associated by a data structure with the authentic account identifier. An enrollment response message containing the plurality of decoy account identifiers is communicated via the network interface toward the mobile terminal.

In some further embodiments, the operations receive, via the network interface from the mobile wallet application of the mobile terminal, a transaction request message containing a user selected account identifier. The user selected account identifier is compared to the plurality of decoy account identifiers and the authentic account identifier. Whether the user selected account identifier matches one of the plurality of decoy account identifiers or matches the authentic account identifier is determined. Responsive to determining that the user selected account identifier matches the authentic account identifier, the operations communicate toward the mobile terminal a first transaction response message containing an authorization indication that authorizes completion of a transaction through the mobile wallet application. Responsive to determining that the user selected account identifier matches one of the plurality of decoy account identifiers, the operations communicate toward the mobile terminal a second transaction response message containing another authorization indication that does not authorize completion of the transaction through the mobile wallet application.

Some other embodiments of the present disclosure are directed to a non-transitory computer readable storage medium storing program code which is executable by a processor of a mobile terminal to perform operations. The operations include receiving an authentic account identifier through a user interface of the mobile terminal from a user. Responsive to a request to enroll an account in a mobile wallet application executed by the processor of the mobile terminal, the operations communicate an enrollment request message via a network interface of the mobile terminal and a data network toward a wallet server. The enrollment request message includes an authentic account identifier received from a user. An enrollment response message containing a plurality of decoy account identifiers is receiving through the network interface from the wallet server. The plurality of decoy account identifiers are saved in a memory of the mobile terminal logically associated by a data structure with the authentic account identifier. Responsive to a user initiating a transaction through the mobile wallet application, the operations display on a display device of the mobile terminal the plurality of decoy account identifiers and the authentic account identifier. Responsive to receiving a user selected account identifier that is displayed among the plurality of decoy account identifiers and the authentic account identifier, the operations communicate through the network interface toward the wallet server a transaction request message containing the user selected account identifier. A transaction response message is received through the network interface from the wallet server. The transaction response message contains an authorization indication. The operations selectively allow completion of the transaction through the mobile wallet application based on the authorization indication.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects of the present disclosure are illustrated by way of example and are not limited by the accompanying figures.

FIG. 1 is a block diagram illustrating a system that includes a mobile terminal on which a mobile wallet app is installed, a wallet server, and an issuer server.

FIG. 2 is a flow diagram illustrating message flows and associated operations by a mobile wallet app and a wallet server in accordance with some embodiments.

FIG. 3 illustrates an array of decoy and authentic card images that can be displayed by a mobile terminal in accordance with some embodiments.

FIG. 4 illustrates operations by a mobile terminal for computing row and column locations for where to display the authentic card image in the array of FIG. 3 in accordance with some embodiments.

FIG. 5 illustrates a scrollable column of decoy and authentic card images that can be displayed by a mobile terminal in accordance with some embodiments.

FIG. 6 illustrates operations by a mobile terminal for computing a column location for where to display the authentic card image in the column of FIG. 5 in accordance with some embodiments.

FIG. 7 is a block diagram of a wallet server that is configured according to some embodiments.

FIG. 8 is a block diagram of a mobile terminal that is configured according to some embodiments.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

With the proliferation of mobile terminals, the card payment industry is moving toward mobile payment applications on mobile terminals. Mobile payment applications, also referred to as mobile wallet applications or mobile wallet apps, are payment services that operate on a mobile terminal and that interact with point of sale terminals or kiosks to facilitate payment for goods or services.

One form of mobile payment involves credit card tokenization. In a system that uses credit card tokenization, a payment token that acts as a substitute for a Primary Account Number (PAN), such as a credit card number, is transmitted to a point of sale (POS) terminal. A payment token service provider may be authorized to provide payment tokens to token requestors, such as card on file merchants, acquirer processors, payment gateways, digital wallet providers, card issuers, and the like. The token service provider may be implemented to run on a server and to receive requests for payment tokens from one or more token requestors. For each payment token request, the token service provider generates a random payment token, which is in some cases a Bank Identification Number (BIN)/Issuer Identification Number (IIN) range that is not currently being used by any active payment card. The token may be given some expiration period and can be used in place of the PAN for a payment card until it expires.

The “Europay, Mastercard and Visa” (EMV) consortium has defined specifications for mobile cards that work within a secure payment infrastructure. All major card brands, including Visa, Mastercard, American Express, Discover, etc., have developed card specifications that derive from the EMV specifications.

One hindrance to the widespread adoption of mobile wallet applications (“apps”) is the risk created by enrolling a plurality of payment cards, such as credit cards or debit cards, in the mobile wallet application. Any fraudster or other unauthorized user who can gained access to the mobile wallet application, e.g., by entering a stolen personal identification number (PIN) or trigger a false-positive fingerprint scan, can then use all of the payment cards therein up to their maximum individual authorization limits.

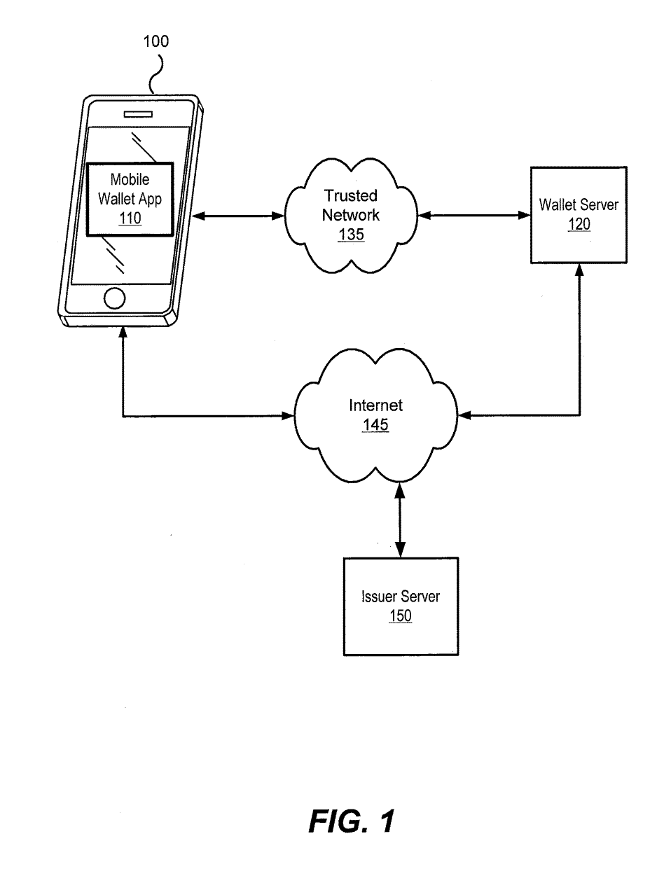

Referring to FIG. 1, a mobile wallet app 110 is installed on and executed by a mobile terminal 100. The mobile terminal 100 may include, but is not limited to, a mobile phone, a tablet computer, a laptop computer, a game console, etc. The mobile wallet app 110 communicates with a remote wallet server 120 over a trusted data network 135, such as private data network or Short Messaging Service (SMS) data network operated by a mobile carrier. The mobile wallet app 110 may additionally or alternatively communicate with the wallet server 120 over a public data network 145, such as the Internet. The mobile terminal 100 may be configured to communicate wirelessly over the data network(s) 135 and/or 145. The wallet server 120 may also communicate over the data network(s) 135 and/or 145 with an issuer server 150 that is operated by a payment card issuer. The issuer server 150 has access to payment card information for payment cards issued by the card issuer. Such information may include primary account numbers (PANs), as well as information associated with the card holder, such as name, address, telephone number, and a PIN.

To enroll a payment card, a user can unlock the mobile wallet app 110 by entering a PIN, a password, or completing a fingerprint or other biometric scan. The user then initiates account enrollment and enters an account identifier (referred to as an authentic account identifier), such as a credit card number, expiration date, cardholder name, and security code, or CVVN code. The authentic account identifier is communicated to the wallet server 120. The wallet server 120 may perform operations to authenticate the user before registering the authentic account identifier, such as using a one-time-password challenge, question and responsive answer challenge, or other authentication generated by the wallet server 120 that the user must properly respond to through the mobile terminal 100.

Some embodiments of the inventive concepts described herein associate a plurality of decoy account identifiers with the authentic account identifier. A user who accesses the mobile wallet app 110 to attempt to use the authentic account identifier for a purchase transaction, must be able to select a displayed image for the authentic account identifier from among other displayed images for the decoy account identifiers. The decoy account identifiers may, for example, have invalid card numbers, invalid expiry dates, and/or invalid CCV numbers, while the authentic account identifier has a valid card number, valid expiry date, and valid CCV number. The decoy account identifier may, for example, each have a card number that differs from the valid account number by one wrong number digit so as to be difficult to distinguish from the authentic card without having a present recollection of all valid account digits.

Different background images can be displayed for each of the authentic and decoy account identifiers. However, the background images for the decoy account identifiers may appear equally plausible choices to a fraudster. An authentic user can recognize and correctly select the background image for the authentic account identifier (e.g., based on recalling the previously viewed background image for the authentic account) for use by the mobile wallet app 110 to complete a transaction through the wallet server 120 and the issuer server 150 to purchase an item, e.g., through near field communications (NFC) between the mobile terminal 100 and a merchant's point of sale terminal and/or through network communication with an merchant's e-commerce server. In sharp contrast, a fraudster would not know the background image for the authentic account identifier and therefore cannot distinguish the background image displayed for with the authentic account identifier from among the background images displayed associated with the decoy account identifiers. Moreover, the fraudster may not know that any of the account identifiers are decoys and should not be selected. The fraudster is therefore likely to erroneously select one of the decoy account identifiers for use in the transaction.

The selected account identifier is contained in a transaction request message which is communicated from the mobile wallet app 110 to the wallet server 120 as part of the operations for performing the purchase transaction. The wallet server 120 has registered the decoy account identifiers in a data structure with an association to the authentic account identifier. When the wallet server 120 receives the authentic account identifier from the mobile terminal 100, it communicates in return a transaction response message containing an authorization indication which indicates that the transaction is being allowed. In sharp contrast, when the wallet server 120 receives one of the decoy account identifiers contained in a transaction request message, it communicates back another transaction response message containing an authorization indication which indicates that the transaction is not being allowed, and may communicate therewith a user authentication challenge that requires the user to properly respond with a one-time-password challenge, an answer(s) to a defined question(s), etc.

Various related operations that can be performed by a mobile terminal 100 and a wallet server 120 are now described. The mobile terminal 100 can perform operations to respond to a user's request to enroll an account in the mobile wallet app 110, by communicating an enrollment request message via a network interface and the data network 135 and/or 145 toward the wallet server 120. The enrollment request message includes an authentic account identifier received from a user through a user interface. The mobile terminal 100 receives through the network interface from the wallet server 120 an enrollment response message containing a plurality of decoy account identifiers. The mobile terminal 100 stores, in a memory of the mobile terminal 100, the plurality of decoy account identifiers logically associated by a data structure with the authentic account identifier.

In some further embodiments, the mobile terminal 100 responds to a user initiating a transaction through the mobile wallet application 110, by displaying on a display device of the mobile terminal 100 the plurality of decoy account identifiers and the authentic account identifier. Responsive to receiving a user selected account identifier that is displayed among the plurality of decoy account identifiers and the authentic account identifier, the mobile terminal 100 communicates through the network interface toward the wallet server 120 a transaction request message containing the user selected account identifier. The mobile terminal 100 receives a transaction response message through the network interface from the wallet server 120. The transaction response message contains an authorization indication. The mobile terminal 100 selectively allows completion of the transaction through the mobile wallet application 110 based on the authorization indication.

The enrollment response message can contain a plurality of decoy card images which are each associated with a different one of the plurality of decoy account identifiers. The mobile terminal 100 can save in the memory the plurality of decoy card images in the data structure that logically associates the plurality of decoy account identifiers and an authentic card image for the authentic account identifier.

Related operations which can be performed by the wallet server 120, include receiving, via a network interface, from the mobile wallet application 110 an enrollment request message an authentic account identifier to be enrolled for the user. The wallet server 120 selects a plurality of decoy account identifiers, and saves, in a memory of the wallet server 120, the plurality of decoy account identifiers logically associated by a data structure with the authentic account identifier. The wallet server 120 communicates, via the network interface toward the mobile terminal 100, an enrollment response message containing the plurality of decoy account identifiers.

In some further embodiments, the wallet server 120 receives, via the network interface from the mobile wallet application 110, a transaction request message containing a user selected account identifier. The wallet server 120 compares the user selected account identifier to the plurality of decoy account identifiers and the authentic account identifier, and determines whether the user selected account identifier matches one of the plurality of decoy account identifiers or matches'the authentic account identifier. Responsive to determining that the user selected account identifier matches the authentic account identifier, the wallet server 120 communicates toward the mobile terminal 100 a first transaction response message containing an authorization indication that authorizes completion of a transaction through the mobile wallet application 110. In contrast, responsive to determining that the user selected account identifier matches one of the plurality of decoy account identifiers, the wallet server 120 communicates toward the mobile terminal 100 a second transaction response message containing another authorization indication that does not authorize completion of the transaction through the mobile wallet application 110, and which may contain a user authentication challenge (e.g., one-time-password challenge, question and answer challenge, etc.).

The wallet server 120 may generate the enrollment response message to contain a plurality of decoy card images which are each associated with a different one of the plurality of decoy account identifiers. The enrollment response message may be generated by the wallet server 120 to contain an authentic card image for the authentic account identifier and contain information identifying a location where the authentic card image is to be displayed among the plurality of decoy card images on a display device of the mobile terminal 100.

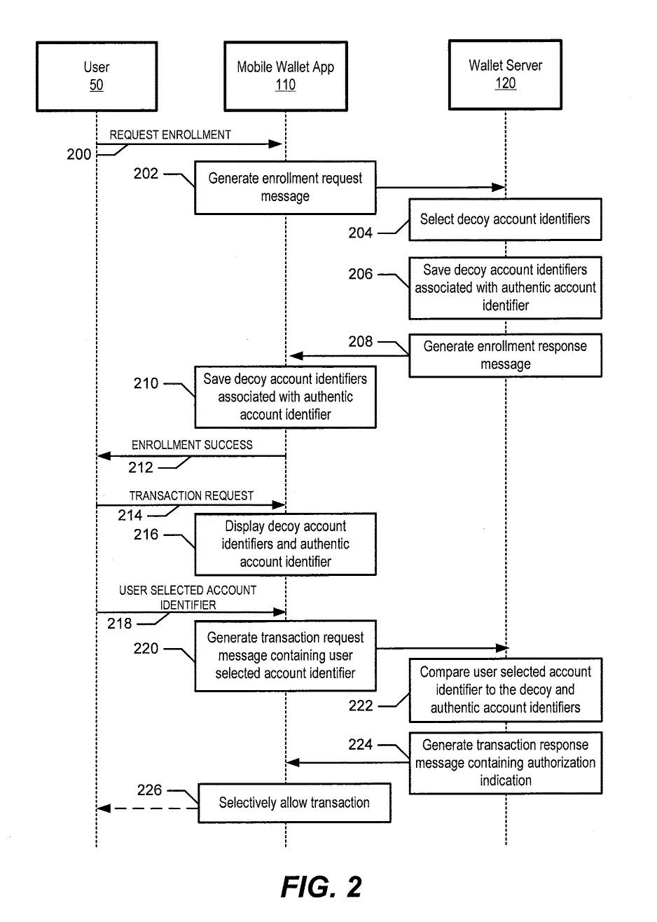

FIG. 2 is a flow diagram illustrating message flows and associated operations by the mobile wallet app 110 and the wallet server 120 in accordance with some embodiments.

Referring to FIG. 2, a user 50 electronically initiates a request 200 to enroll an account in the mobile wallet application 110. The mobile wallet application 110 generates (Block 202) an enrollment request message that includes an authentic account identifier received from the user. The enrollment request message may additionally include a unique identifier for the mobile terminal 100, e.g., a media access control (MAC) address and/or a subscriber identification number, such as an International Mobile Subscriber Identity (IMSI) or International Mobile Station Equipment Identity (IMEI) associated with the mobile terminal 100. The wallet server 120 receives the enrollment request message and responsively selects (Block 204) a plurality of already defined a plurality of decoy account identifiers by, e.g., selecting among a plurality of already defined identifiers or generating the identifiers. The wallet server 120 then saves (Block 206) the decoy account identifiers logically associated by a data structure with the authentic account identifier. The wallet server 120 generates (Block 208) an enrollment response message containing the plurality of decoy account identifiers, which is communicated to the mobile wallet application 110. The mobile wallet application 110 saves (Block 2 7) the decoy account identifiers in a memory logically associated by a data structure with the authentic account identifier. The mobile wallet application 110 displays (Block 212) to the user an indication of the successful completion of the enrollment operations.

Subsequently, the same or another user accesses the mobile wallet application 110, e.g., by entering a defined PIN or completing a fingerprint or other biometric recognition operation, and electronically initiates (Block 214) a transaction request for purchasing an item. The wallet application 110 displays (Block 216) the plurality of decoy account identifiers and the authentic account identifier. The user electronically selects (Block 218), such as by touch selecting one of the displayed account identifiers through a touch sensitive interface on the display device. The mobile wallet application 110 responsively generates a transaction request message containing the user selected account identifier, and communicates the message toward the wallet server 120. The wallet server 120 receives and compares (Block 222) the user selected account identifier to the list of decoy and account identifiers which it had stored in the memory. The wallet server 120 determines whether the user selected account identifier matches one of the plurality of decoy account identifiers or matches the authentic account identifier.

The wallet server 120 responds to determining (Block 224) that the user selected account identifier matches the authentic account identifier, by communicating toward the mobile terminal 100 a transaction response message containing an authorization indication that authorizes completion of a transaction through the mobile wallet application 110, and/or may communicate transaction information to the issuer server 150 requesting authorization of the transaction and include a response from the issuer server 150 in the decision by the wallet server 120 whether to authorize (Block 224) the transaction. In contrast, responsive to determining (Block 224) that the user selected account identifier matches one of the plurality of decoy account identifiers, the wallet server 120 communicates toward the mobile terminal 100 another transaction response message containing another authorization indication that does not authorize completion of the transaction through the mobile wallet application 110. Accordingly, in one embodiment, the wallet server 120 does not automatically send transaction information to the issuer server 150 to request authorization, but instead either declines the transaction or communicates a challenge response to the mobile wallet app 110 which must be properly satisfied by the user before the wallet server 120 sends the transaction information to the issuer server 150 to request authorization.

The mobile wallet app 110 responds (Block 226) to the transaction response message by selectively allowing the transaction. The mobile wallet app 110 may respond to the indication that the transaction is authorized by performing further operations that can include displaying a message indicating that the transaction has been successfully performed or sending further information to the wallet server 120 and/or the issuer server 150 that is needed to complete the transaction. The mobile wallet app 110 may respond to the indication that the transaction is not authorized by terminating the transaction and displaying a related termination notification to the user, or by challenging the user to enter a PIN, a password, and/or providing a biometric measurement that is authenticated by the mobile wallet app 110 and/or by wallet server 120 in order to complete the transaction.

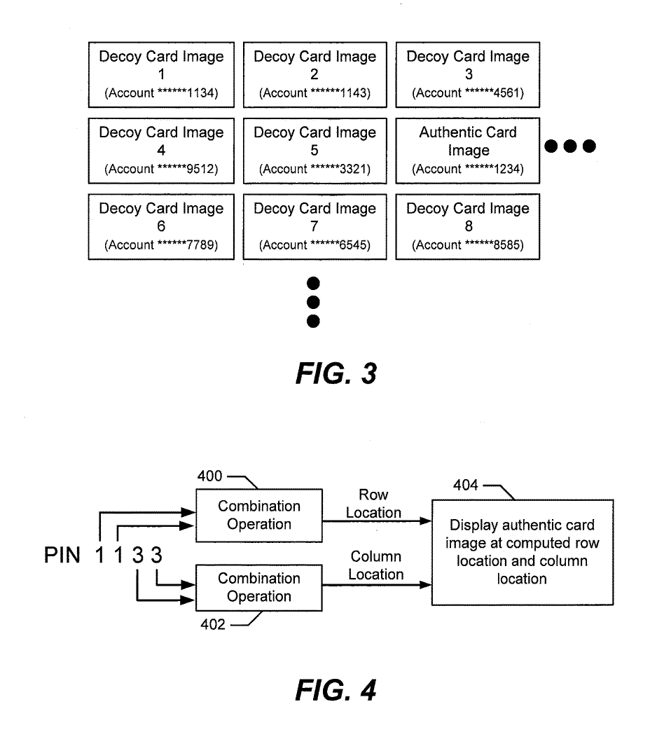

FIG. 3 illustrates an array of decoy and authentic card images that can be displayed by the mobile terminal 100 in accordance with some embodiments.

Referring to FIG. 3, the mobile terminal 100 can operate to receive in the enrollment response message from the wallet server 120, a plurality of decoy card images which are each associated with a different one of the plurality of decoy account identifiers. The mobile terminal 100 can then operate to save in the memory the plurality of decoy card images in the data structure that logically associates the plurality of decoy account identifiers and an authentic card image for the authentic account identifier. Responsive to a user initiating a transaction through the mobile wallet application 110, the mobile terminal 100 can display the plurality of decoy card images and the authentic card image arranged in an array of columns and rows on the display device.

In one embodiment, the mobile terminal 100 determines where to display the authentic card image in the array at a column and row location that is the same over a plurality of repeated cycles of user initiated transactions through the mobile wallet application 110. For example, when the user triggers execution of the mobile wallet application 110 for a first purchase transaction, the mobile terminal 100 displays the plurality of decoy card images and the authentic card image arranged in an array of columns and rows on the display device. The mobile terminal 100 can display the authentic card image at a first location (addressed at column 3 and row 2 as shown in FIG. 3). Subsequently, when the user again triggers execution of the mobile wallet application 110 for a second purchase transaction, the mobile terminal 100 can display the authentic card image at the same first location (again addressed at column 3 and row 2 as shown in FIG. 3). The mobile terminal 100 identifies the user selected account identifier based on identifying one of the plurality of decoy card images and the authentic card image that is selected by the user through the user interface. An authentic user can therefore identify the authentic card image from among the plurality of decoy card images based, at least in part, on knowing the static array location of the authentic card image.

In another embodiment, the mobile terminal 100 determines where to display the authentic card image in the array at a column and row location that is controlled to change, between repeated cycles of user initiated transactions through the mobile wallet application 110, according to a sequence of location movements in the array that has been defined by a user. For example, when the user triggers execution of the mobile wallet application 110 for a first purchase transaction, the mobile terminal 100 displays the plurality of decoy card images and the authentic card image arranged in an array of columns and rows on the display device. The mobile terminal 100 displays the authentic card image at a first location (addressed as column 3 and row 2 as shown in FIG. 3). Subsequently, when the user again triggers execution of the mobile wallet application 110 for a second purchase transaction, the mobile terminal 100 computes a second location in the array according to a sequence of location movements in the array that has been defined by a user. The defined sequence may move the authentic card image to the left by one column so that the authentic card image is then displayed at address column 2 and row 2. Still subsequently, then the user again triggers execution of the mobile wallet application 110 for a third purchase transaction, the mobile terminal 100 may move the authentic card image left by another column so that the authentic card image is then displayed at address column 1 and row 2. The mobile terminal 100 identifies the user selected account identifier based on identifying one of the plurality of decoy card images and the authentic card image that is selected by the user through the user interface. An authentic user can therefore identify the authentic card image from among the plurality of decoy card images based, at least in part, on knowing where the authentic card image was last displayed during a transaction and where it would now be displayed based on the defined pattern of movement (e.g., sequentially moving left one column for a next location to be displayed for a next transaction following completion of a present transaction).

FIG. 4 illustrates operations by the mobile terminal 100 for computing row and column locations for where to display the authentic card image in the array of FIG. 3 in accordance with some embodiments.

Referring to FIG. 4, the mobile terminal 100 determines where to display the authentic card image in the array at a column and row location that is computed based on content of an identification number received from a user. The identification number may correspond to a defined portion of the authentic account identifier, such as the last four digits of the credit card number. Alternatively, the identification number corresponds to a PIN that the user entered to unlock the mobile wallet application 110. Although various embodiments seek to provide additional security to accounts registered in the mobile wallet when a PIN to unlock the wallet has improperly become known by a fraudster, such fraudster would not know how to compute the location of the authentic account identifier within the array based on the PIN.

When the user triggers execution of the mobile wallet application 110 for a purchase transaction, the mobile terminal 100 displays the plurality of decoy card images and the authentic card image arranged in an array of columns and rows on the display device. The mobile terminal 100 displays the plurality of decoy card images and the authentic card image arranged in an array of columns and rows on the display device, and displays the authentic card image in the array at a column and row location that is computed based on content of an identification number received from the user. In one further embodiment, the mobile terminal 100 computes the column location to display the authentic card image based on mathematically combining values of a first pair of digit locations in the identification number, and computes the row location to display the authentic card image based on mathematically combining values of a second pair of digit locations in the identification number. The mobile terminal 100 then displays the authentic card image at the column location and the row location that is computed, and displays the plurality of decoy card images at at least some of the other column and row locations in the array.

For example, as shown in FIG. 4, the mobile terminal 100 performs a combination operation (Block 400) that mathematically combines the first two digits of the PIN to compute a row location, and performs a combination operation (Block 402) that mathematically combines the last two digits of the PIN to compute a column location. The mobile terminal 100 then displays (Block 404) the authentic card image at the computed row location and column location. One or both of the combination operations may mathematically combine the two digits by, for example, adding, subtracting (e.g., taking an absolute value of the result or rounding negative results to zero), or multiplying the digits. Any plural number of digits may be combined and any locations within a numerical string may be combined to compute the row and/or the column location in the array for display of the authentic card image.

In another embodiment, the mobile terminal 100 displays the authentic card image at a row location and a column location in the array that each defined by one or two digits of the PIN. For example, the first digit of the PIN may define the row location (e.g., row 1 in FIG. 4) and the fourth digit of the PIN may define the column location (e.g., column 3 in FIG. 4). Alternatively, the row location and the column location may be defined by the same digit (e.g., the first digit “1” defines the first row and the first column).

Corresponding or alternative operations may be performed by the wallet server 120 to define the location in the array where the authentic card image is to be displayed, and can communicate the determined location to the mobile wallet app 110. In one embodiment, when generating the enrollment response message, the wallet server 120 generates the enrollment response message to contain location information identifying locations where the authentic card image and the plurality of decoy card images are to be displayed arranged in an array of columns and rows on the display device of the mobile terminal 100.

In a further embodiment, the wallet server 120 computes the column location in the array where the authentic card image is to be displayed based on mathematically combining values of a first pair of digit locations in an identification number retrieved from the data structure with a defined association to the user, and computes the row location in the array where the authentic card image is to be displayed based on mathematically combining values of a second pair of digit locations in an identification number retrieved from the data structure with a defined association to the user. The wallet server 120 then generates the location information based on the column location and the row location. Thus, in a similar manner to the operations shown in FIG. 6, the wallet server 120 may combine the first two PIN digits to compute the row location and combine the last two PIN digits to compute the column location. The row and column locations are then communicated in the enrollment response message from the wallet server 120 to the mobile terminal 100 for use by the mobile wallet app 110 to display the images.

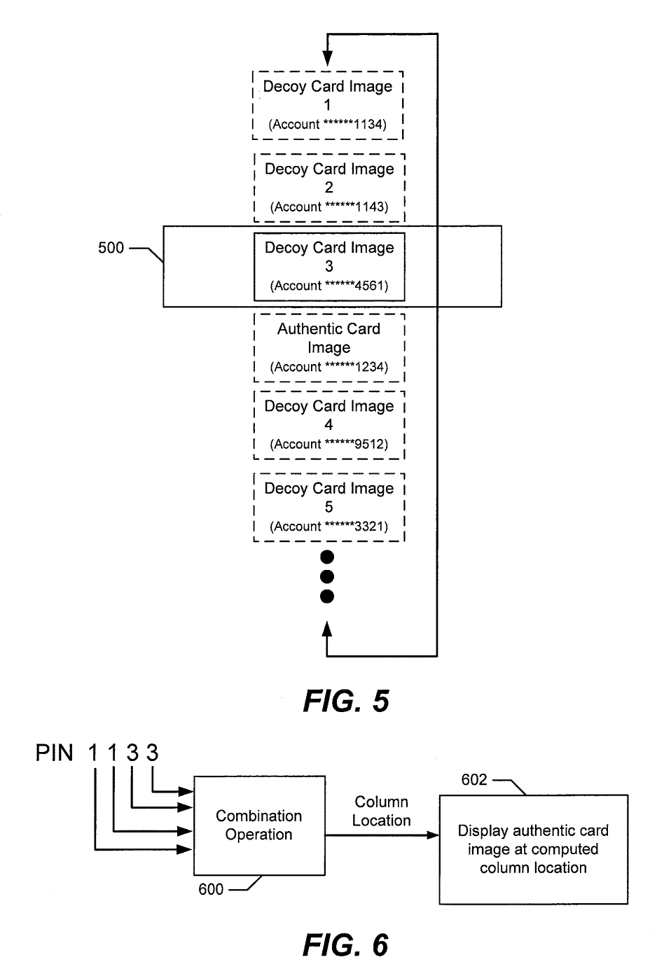

FIG. 5 illustrates a scrollable column of decoy and authentic card images that can be displayed by the mobile terminal 100 in accordance with some embodiments.

Referring to FIG. 5, responsive to a user initiating a transaction through the mobile wallet application 110, the mobile terminal 100 displays on the display device the plurality of decoy account identifiers and the authentic account identifier in a scrollable column. Responsive to each instance of a display scroll command received through the user interface from a user (e.g., a user touch dragging the column upward/downward), the mobile terminal 100 correspondingly selects a card image from among the plurality of decoy card images and the authentic card image, and displays the selected card image on the display device.

In one embodiment, the selected card image is displayed within a display window 500 that is configured to display a single card image at a time. A user may scroll upward and downward along the column to view other card images within the window 500 by, for example, sliding a finger in a corresponding direction to virtually drag the card images in the desired upward or downward direction. The mobile terminal 100 identifies a user selected account identifier based on identifying one of the plurality of decoy card images and the authentic card image that is selected by the user through the user interface, and communicates through the network interface toward the wallet server 120 a transaction request message containing the user selected account identifier.

FIG. 6 illustrates operations by the mobile terminal 100 for computing a column location for where to display the authentic card image in the column of FIG. 5 in accordance with some embodiments.

Referring to FIG. 6, the mobile terminal 100 determines where to display the authentic card image a row location in the column that is computed based on content of an identification number received from a user. The identification number may correspond to a defined portion of the authentic account identifier, such as the last four digits of the credit card number. Alternatively, the identification number corresponds to a PIN that the user entered to unlock the mobile wallet application 110.

When the user triggers execution of the mobile wallet application 110 for a purchase transaction, the mobile terminal 100 displays the plurality of decoy card images and the authentic card image arranged in a column, where at least one card image in the column is visible at a time on the display device. The mobile terminal 100 displays the authentic card image at a row location in the column that is computed based on content of an identification number received from the user. In one further embodiment, the mobile terminal 100 computes the row location based on mathematically combining values of the identification number. The mobile terminal 100 then displays the authentic card image at the row location in the column that is computed.

For example, as shown in FIG. 6, the mobile terminal 100 performs a combination operation (Block 600) that mathematically combines all four digits of the PIN to compute the row location in the column. The mobile terminal 100 then displays (Block 602) the authentic card image at the computed row location, which may not be presently visible to a user if the computed row location does not correspond to the presently viewable window 500 along the column. The combination operation may mathematically combine any two or more defined digits by, for example, adding, subtracting (e.g., taking an absolute value of the result or rounding negative results to zero), or multiplying the digits. Any plural number of digits may be combined and any locations within a numerical string may be combined to compute the row location in the column for display of the authentic card image.

In another embodiment, the mobile terminal 100 displays the authentic card image at a row location in the column that is defined by one digit of the PIN. For example, the first digit of the PIN may define the row location.

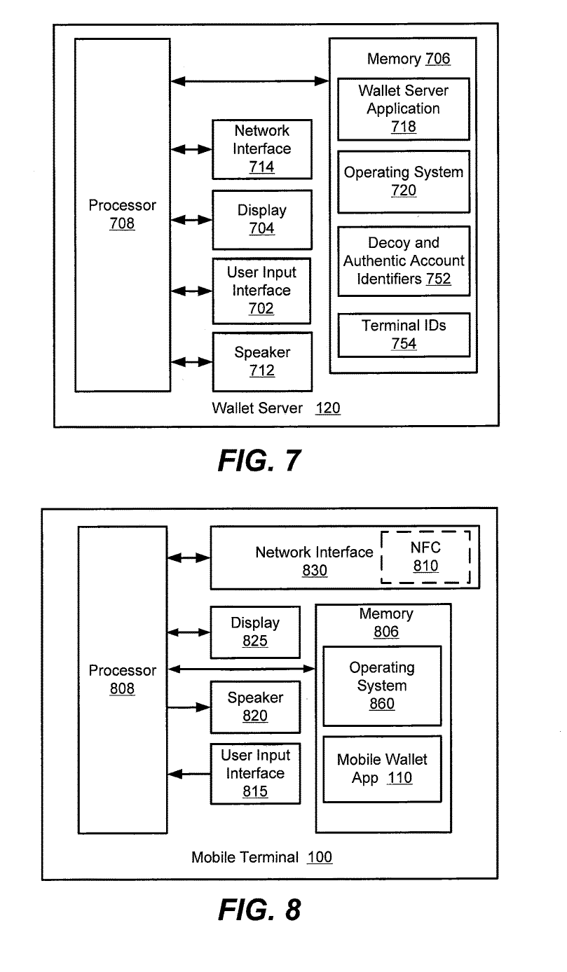

FIG. 7 is a block diagram of a wallet server 120 that is configured according to some embodiments. The wallet server 120 includes a processor 708 that communicates with a memory 706, and one or more network interfaces 714. The wallet server 120 may also include a display device 704, an user input interface 702, and a speaker 712. The memory 706 stores program code and data that configures the wallet server 120 for operation. In particular, the memory 706 may store a wallet server application 718, a repository 752 of data structures containing decoy and authentic account identifiers, and a repository 754 of terminal IDs, and an operating system 720. The processor 708 executing the wallet server application 718 causes the wallet server 120 to perform operations disclosed herein according to one or more embodiments.

A mobile terminal 100 according to some embodiments is illustrated in FIG. 8. The mobile terminal 100 includes a processor 808 that communicates with a memory 806 and a network interface 830. The network interface 130 is configured to communicate with the wallet server 120 via one or more data networks through a wired and/or wireless communication pathway. The mobile terminal 100 may also include a display 825, a user input interface 815 (e.g., a touch sensitive interface), and a speaker 820.

The network interface 830 may include a near field communications (NFC) module 810. NFC is a set of standards that enable short-range, bidirectional wireless communication between terminals by touching them together or bringing them into close proximity, usually no more than a few inches. NFC standards cover communications protocols and data exchange formats, and are based on existing radio-frequency identification (RFID) standards. The NFC module 810 may communicate with a merchant's point of sale terminal to communicate the transaction request message containing the user selected account identifier toward the wallet server 120 and to receive the responsive transaction response message from the wallet server 120. The network interface 830 may additionally or alternatively include other wireless communication transceiver, such as Bluetooth and Wi-Fi, that are used to communicate with the wallet server 120.

The memory 806 stores program code and data that configure the mobile terminal 100 for operation. In particular, the memory 806 may store an operating system 860 and the mobile wallet app 110. The mobile wallet app 110 when exceeded by the processor 808 causes the mobile terminal 100 to perform operations disclosed herein according to one or more embodiments.

To conduct a transaction, a user may select one of the account identifiers from among a plurality of account identifiers stored in the mobile wallet app 110 of the user terminal 100. The user may hold the user terminal 100 near the merchant point-of-sale (POS) terminal. The POS terminal and the user terminal 100 start a session where they communicate using the NFC interface 810. The mobile terminal 100 and the POS terminal may exchange messages according to a defined protocol. Included in these messages can be the transaction request message and the transaction response message. The transaction request message may include the date, transaction type, transaction amount, merchant identifier, etc.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a buffered repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JavaScript, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable storage medium that when executed can direct a computer, other programmable data processing apparatus, or other devices to function in a particular manner, such that the instructions when stored in the computer readable storage medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a processor of a mobile terminal:
responsive to a request to enroll an account in a mobile wallet application executed by the processor of the mobile terminal, communicating an enrollment request message via a network interface of the mobile terminal and a data network toward a wallet server, the enrollment request message including an authentic account identifier received from a user through a user interface;
receiving through the network interface from the wallet server an enrollment response message containing a plurality of decoy account identifiers; and
saving in a memory of the mobile terminal the plurality of decoy account identifiers logically associated by a data structure with the authentic account identifier.

2. The method of claim 1, further comprising:
responsive to a user initiating a transaction through the mobile wallet application, displaying on a display device of the mobile terminal the plurality of decoy account identifiers and the authentic account identifier;
responsive to receiving a user selected account identifier that is displayed among the plurality of decoy account identifiers and the authentic account identifier, communicating through the network interface toward the wallet server a transaction request message containing the user selected account identifier;
receiving a transaction response message through the network interface from the wallet server, the transaction response message containing an authorization indication; and
selectively allowing completion of the transaction through the mobile wallet application based on the authorization indication.

3. The method of claim 2,
wherein the receiving through the network interface from the wallet server an enrollment response message containing a plurality of decoy account identifiers, comprises
receiving in the enrollment response message a plurality of decoy card images each associated with a different one of the plurality of decoy account identifiers; and
wherein the saving in a memory of the mobile terminal the plurality of decoy account identifiers logically associated by a data structure with the authentic account identifier, comprises
saving in the memory the plurality of decoy card images in the data structure that logically associates the plurality of decoy account identifiers and an authentic card image for the authentic account identifier.

4. The method of claim 3,
wherein the responsive to a user initiating a transaction through the mobile wallet application, displaying on a display device of the mobile terminal the plurality of decoy account identifiers and the authentic account identifier, comprises
displaying the plurality of decoy card images and the authentic card image arranged in an array of columns and rows on the display device, the authentic card image being displayed in the array at a column and row location that is the same over a plurality of repeated cycles of user initiated transactions through the mobile wallet application; and
wherein the responsive to receiving a user selected account identifier that is displayed among the plurality of decoy account identifiers and the authentic account identifier, communicating through the network interface toward the wallet server a transaction request message containing the user selected account identifier, comprises
identifying the user selected account identifier based on identifying one of the plurality of decoy card images and the authentic card image that is selected by the user through the user interface.

5. The method of claim 3,
wherein the responsive to a user initiating a transaction through the mobile wallet application, displaying on a display device of the mobile terminal the plurality of decoy account identifiers and the authentic account identifier, comprises
displaying the plurality of decoy card images and the authentic card image arranged in an array of columns and rows on the display device, the authentic card image being displayed in the array at a column and row location that is controlled to change, between repeated cycles of user initiated transactions through the mobile wallet application, according to a sequence of location movements in the array that has been defined by a user; and
wherein the responsive to receiving a user selected account identifier that is displayed among the plurality of decoy account identifiers and the authentic account identifier, communicating through the network interface toward the wallet server a transaction request message containing the user selected account identifier, comprises
identifying the user selected account identifier based on identifying one of the plurality of decoy card images and the authentic card image that is selected by the user through the user interface.

6. The method of claim 3,
wherein the responsive to a user initiating a transaction through the mobile wallet application, displaying on a display device of the mobile terminal the plurality of decoy account identifiers and the authentic account identifier, comprises
displaying the plurality of decoy card images and the authentic card image arranged in an array of columns and rows on the display device, the authentic card image being displayed in the array at a column and row location that is computed based on content of an identification number received from a user; and
wherein the responsive to receiving a user selected account identifier that is displayed among the plurality of decoy account identifiers and the authentic account identifier, communicating through the network interface toward the wallet server a transaction request message containing the user selected account identifier, comprises
identifying the user selected account identifier based on identifying one of the plurality of decoy card images and the authentic card image that is selected by the user through the user interface.

7. The method of claim 6, wherein the displaying the plurality of decoy card images and the authentic card image arranged in an array of columns and rows on the display device, the authentic card image being displayed in the array at a column and row location that is computed based on content of an identification number received from a user, comprises:
computing the column location to display the authentic card image based on mathematically combining values of a first pair of digit locations in the identification number;
computing the row location to display the authentic card image based on mathematically combining values of a second pair of digit locations in the identification number; and
displaying the authentic card image at the column location and the row location that is computed, and displaying the plurality of decoy card images at at least some of the other column and row locations in the array.

8. The method of claim 7, wherein the identification number comprises a defined portion of the authentic account identifier.

9. The method of claim 7, further comprising:
prior to the displaying on a display device of the mobile terminal the plurality of decoy account identifiers and the authentic account identifier, unlocking the mobile wallet application responsive to receiving a defined personal identification number through the user interface from the user,
wherein the identification number comprises the defined personal identification number.

10. The method of claim 3,
wherein the responsive to a user initiating a transaction through the mobile wallet application, displaying on a display device of the mobile terminal the plurality of decoy account identifiers and the authentic account identifier, comprises
responsive each instance of a display scroll command received through the user interface from a user, selecting a card image from among the plurality of decoy card images and the authentic card image, and displaying the selected card image on the display device; and
wherein the responsive to receiving a user selected account identifier that is displayed among the plurality of decoy account identifiers and the authentic account identifier, communicating through the network interface toward the wallet server a transaction request message containing the user selected account identifier, comprises
identifying the user selected account identifier based on identifying one of the plurality of decoy card images and the authentic card image that is selected by the user through the user interface.

11. A method, comprising:
performing operations as follows on a processor of a wallet server:
receiving, via a network interface of the wallet server from a mobile wallet application executed by a mobile terminal, an enrollment request message an authentic account identifier to be enrolled for a user;
selecting a plurality of decoy account identifiers;
saving in a memory of the wallet server the plurality of decoy account identifiers logically associated by a data structure with the authentic account identifier; and
communicating, via the network interface toward the mobile terminal, an enrollment response message containing the plurality of decoy account identifiers.

12. The method of claim 11, further comprising:
receiving, via the network interface from the mobile wallet application of the mobile terminal, a transaction request message containing a user selected account identifier;
comparing the user selected account identifier to the plurality of decoy account identifiers and the authentic account identifier;
determining whether the user selected account identifier matches one of the plurality of decoy account identifiers or matches the authentic account identifier;
responsive to determining that the user selected account identifier matches the authentic account identifier, communicating toward the mobile terminal a first transaction response message containing an authorization indication that authorizes completion of a transaction through the mobile wallet application; and
responsive to determining that the user selected account identifier matches one of the plurality of decoy account identifiers, communicating toward the mobile terminal a second transaction response message containing another authorization indication that does not authorize completion of the transaction through the mobile wallet application.

13. The method of claim 12, wherein the communicating, via the network interface toward the mobile terminal, an enrollment response message containing the plurality of decoy account identifiers, further comprises
generating the enrollment response message to contain a plurality of decoy card images each associated with a different one of the plurality of decoy account identifiers.

14. The method of claim 13, wherein the generating the enrollment response message to contain a plurality of decoy card images each associated with a different one of the plurality of decoy account identifiers, further comprises
generating the enrollment response message to contain an authentic card image for the authentic account identifier and contain information identifying a location where the authentic card image is to be displayed among the plurality of decoy card images on a display device of the mobile terminal.

15. The method of claim 14, wherein the generating the enrollment response message to contain an authentic card image for the authentic account identifier and contain information identifying a location where the authentic card image is to be displayed among the plurality of decoy card images on a display device of the mobile terminal, further comprises
generating the enrollment response message to contain location information identifying locations where the authentic card image and the plurality of decoy card images are to be displayed arranged in an array of columns and rows on the display device of the mobile terminal.

16. The method of claim 15, wherein the generating the enrollment response message to contain information identifying locations where the authentic card image and the plurality of decoy card images are to be displayed arranged in an array of columns and rows on the display device of the mobile terminal, further comprises
computing the column location in the array where the authentic card image is to be displayed based on mathematically combining values of a first pair of digit locations in an identification number retrieved from the data structure with a defined association to the user;
computing the row location in the array where the authentic card image is to be displayed based on mathematically combining values of a second pair of digit locations in an identification number retrieved from the data structure with a defined association to the user; and
generating the location information based on the column location and the row location.

17. A computer program product comprising:
a non-transitory computer readable storage medium storing program code executable by a processor of a mobile terminal to perform operations comprising:
responsive to a request to enroll an account in a mobile wallet application executed by the processor of the mobile terminal, communicating an enrollment request message via a network interface of the mobile terminal and a data network toward a wallet server, the enrollment request message including an authentic account identifier received from a user through a user interface;
receiving through the network interface from the wallet server an enrollment response message containing a plurality of decoy account identifiers;
saving in a memory of the mobile terminal the plurality of decoy account identifiers logically associated by a data structure with the authentic account identifier;
responsive to a user initiating a transaction through the mobile wallet application, displaying on a display device of the mobile terminal the plurality of decoy account identifiers and the authentic account identifier;
responsive to receiving a user selected account identifier that is displayed among the plurality of decoy account identifiers and the authentic account identifier, communicating through the network interface toward the wallet server a transaction request message containing the user selected account identifier;
receiving a transaction response message through the network interface from the wallet server, the transaction response message containing an authorization indication; and
selectively allowing completion of the transaction through the mobile wallet application based on the authorization indication.

18. The computer program product of claim 17,
wherein the receiving through the network interface from the wallet server an enrollment response message containing a plurality of decoy account identifiers, comprises
receiving in the enrollment response message a plurality of decoy card images each associated with a different one of the plurality of decoy account identifiers; and
wherein the saving in a memory of the mobile terminal the plurality of decoy account identifiers logically associated by a data structure with the authentic account identifier, comprises
saving in the memory the plurality of decoy card images in the data structure that logically associates the plurality of decoy account identifiers and an authentic card image for the authentic account identifier.

19. The computer program product of claim 18,
wherein the responsive to a user initiating a transaction through the mobile wallet application, displaying on a display device of the mobile terminal the plurality of decoy account identifiers and the authentic account identifier, comprises
displaying the plurality of decoy card images and the authentic card image arranged in an array of columns and rows on the display device, the authentic card image being displayed in the array at a column and row location that is computed based on content of an identification number received from a user; and
wherein the responsive to receiving a user selected account identifier that is displayed among the plurality of decoy account identifiers and the authentic account identifier, communicating through the network interface toward the wallet server a transaction request message containing the user selected account identifier, comprises
identifying the user selected account identifier based on identifying one of the plurality of decoy card images and the authentic card image that is selected by the user through the user interface.

20. The computer program product of claim 18,
wherein the responsive to a user initiating a transaction through the mobile wallet application, displaying on a display device of the mobile terminal the plurality of decoy account identifiers and the authentic account identifier, comprises
responsive each instance of a display scroll command received through the user interface from a user, selecting a card image from among the plurality of decoy card images and the authentic card image, and displaying the selected card image on the display device; and
wherein the responsive to receiving a user selected account identifier that is displayed among the plurality of decoy account identifiers and the authentic account identifier, communicating through the network interface toward the wallet server a transaction request message containing the user selected account identifier, comprises
identifying the user selected account identifier based on identifying one of the plurality of decoy card images and the authentic card image that is selected by the user through the user interface.
